(19) United States
(12) Patent Application Publication
(10) Pub. No.: US 2026/0339278 A1
(43) Pub. Date: Oct. 29, 2026

(54) METHOD OF GENERATING AN OUTPUT SIGNAL FROM A VIRTUAL SENSOR OF AN INDUSTRIAL MACHINE WITH RELIABILITY/CONFIDENCE CHECK

(71) Applicant: NUOVO PIGNONE TECNOLOGIE - S.R.L., Florence (IT)

(72) Inventors: Antonino GRAZIANO, Florence (IT); Valentina GORI, Florence (IT); Giacomo VENERI, Florence (IT); Marzia SEPE, Florence (IT); Valeria BALLARINI, Florence (IT); Luca STRAZZERA, Florence (IT)

(21) Appl. No.: 18/997,395

(22) PCT Filed: Jul. 24, 2023
(86) PCT No.: PCT/EP2023/025347

§ 371 Date: Jan. 21, 2025

(30) Foreign Application Priority Data
Jul. 26, 2022 (IT) 102022000015669

(51) Int. Cl. G05B 13/02

(52) U.S. Cl. CPC G05B 13/027

(57) ABSTRACT

According to the innovative method an output signal from a virtual sensor of an industrial machine is generated; the output signal corresponds to a sequence of values of an output variable of a software model; the output variable relates to measurement or evaluation of a parameter of the industrial machine; the method comprises steps to be performed during machine operation time: a) receiving at least one input sequence of values of at least one input variable of the software model relating to at least one physical quantity of the industrial machine, and b) predicting an output sequence of values of the output variable through the software model based on the at least one input sequence, and making predictions, and reliability and statistical evaluations therefrom.

### TECHNICAL FIELD

The subject matter disclosed herein relates to method of generating an output signal from a virtual sensor of an industrial machine that takes into account inaccuracies of the virtual sensor, in particular one or more prediction values from a predictor in the virtual sensor may be discarded if considered not reliable. Furthermore, the subject matter disclosed herein relates to virtual sensor and a system for making an assessment on an industrial machine.

### BACKGROUND ART

Virtual sensors are becoming more and more popular in the field of industrial control, in particular in the field of Oil & Gas.

As known, a virtual sensor is usually a piece of software that is able to provide a signal relating to a physical quantity inside an industrial system, for example a temperature or a pressure, when it is not possible or desirable to directly measure this physical quantity through a physical sensor. The virtual sensor predicts values of the variable of interest based on values of one or more other variables that are directly measured in or on the industrial system.

Virtual sensors are often based on artificial intelligence and may require a preliminary training through e.g. machine learning.

The accuracy of a virtual sensor typically depends on its preliminary training and the data used for the training.

Ideally, a virtual sensor should be trained in combination with exactly the same industrial machine intended to be subject to virtual measurement during operation. In other words, the “domain” used for training of the virtual sensor should be used also for operation or normal operation of the virtual sensor. Using different domains is already known; for example, the article of L. Strazzera, V. Gori and G. Veneri entitled “DANNTe: a case study of a turbo-machinery sensor virtualization under domain shift” and published in 2021 in connection with the Conference on Neural Information Processing Systems, describes a turbo-machinery application consisting in building a virtual sensor using data collected from a machine during winter-time, so-called “source domain”, and applying it to data collected from the same machine during summer-time, so-called “target domain”.

The article of Hossein Shahabadi Farahani et al. entitled “A Novel Method for Designing Transferable Soft Sensors and its Application” in the arxiv.org of the Cornell University, discloses domain-adversarial training in order to “transfer” a “soft sensor” from one plant (corresponding to a “source domain”) to another plant (corresponding to a “target domain”). According to this article, once the “soft sensor” is properly and adequately “transferred” through the domain-adversarial training, its output is used in the new plant and the produced output is always considered correct.

The patent application published as US 2021/110147 A1 discloses systems and methods specific for image processing, in particular for human detection in different scenes, i.e. different “domains”. This document teaches to use domain-adversarial learning. According to this document, when confidence score for an image is low, i.e. when the prediction provided by the system regarding the scene is not sufficiently reliable, the system does not annotate the image automatically but requests a human being to do it. Furthermore, the system requires annotated data belonging to the target domain from the early beginning; in fact, this document discloses a semi-automatic domain adaptation.

It would be desirable that the “target domain” would be more different from the “source domain”. In particular, it would be desirable to train the virtual sensor on a “prototype machine”, for example at the premises of the machine manufacturer, and to use the trained virtual sensor with a “fleet machine”, i.e. a machine installed and operating at the premises of a user, typically a client of the machine manufacturer. The more the domains are different the more inaccuracies are likely. The Applicant has therefore thought of taking the risk of inaccuracies into account in particular those due to difference between the “source domain” and the “target domain”.

### SUMMARY

According to a first aspect, the subject matter disclosed herein relates to a computer-implemented method for generating an output signal from a virtual sensor of an industrial machine that is based on a software model having input variable(s) relating to physical quantity(ies) of the industrial machine and output variable(s) relating to measurement or evaluation of parameter(s) of the industrial machine. During machine operation time, values of the output variable are predicted and one or more of them may be discarded based on calculated flags and/or values relating to e.g. the reliability and/or the confidence level of the prediction.

According to a second aspect, the subject matter disclosed herein relates to a machine learning artificial intelligence virtual sensor for an industrial machine; the output of the virtual sensor relates to measurement or evaluation of a parameter of the industrial machine. It comprises a features extractor, a domain classifier, a predictor and a discarder; the output of the predictor corresponds to the output of the virtual sensor. At training time, the extractor, the classifier and the predictor are active and the discarder is inactive. At machine operation time, the extractor, the classifier, the predictor and the discarder are all active.

According to a third aspect, the subject matter disclosed herein relates to a computer-implemented system for making an assessment on an industrial machine. It comprise at least one virtual sensor of the industrial machine that is configured to output only those predicted values that have a certain reliability and/or a certain confidence level.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic block diagram of an embodiment of an innovative virtual sensor,

FIG. 2 shows a schematic block diagram of an embodiment of an innovative assessment system, and

FIG. 3 shows a flowchart of an embodiment of an innovative method of generating an output signal from a virtual sensor.

### DETAILED DESCRIPTION OF EMBODIMENTS

A virtual sensor is usually a piece of software able to provide values of a variable inside an industrial system, for example a temperature or a pressure that is not possible or desirable to directly measure through a physical sensor; in general, the output of a virtual sensor may relate to a measurement or evaluation of a parameter of an industrial machine. The values first computed and then provided by a virtual sensor may be affected by (e.g. computation) errors. The innovative virtual sensor is able to judge by itself whether a value computed by the virtual sensor is erroneous or excessively erroneous and discard it. In the case of the innovative virtual sensor, errors may be due to the fact that the virtual sensor is trained at least partially with a prototype machine and not totally with a production machine.

It is to be noted that the expression “during machine operation time” is used herein to distinguish from “during training time” as in general a virtual sensor is first trained and then used. However, the expression “during machine operation time” does not exclude that once training is finished there may be a delay (fixed or variable) (short, for example 1 second, or long, for example 1 year) between the time when some data a collected from physical sensor or sensors and the time when such collected data are processed by an innovative virtual sensor in order to generate an output signal. It is not to be excluded that an innovative virtual sensor may have a first training period, afterwards a first operation period, afterwards a second training period, afterwards a second operation period, etc. Additionally, it is not to be excluded that an operation period may at least partially overlaps with a training period; in this case, the innovative virtual sensor learns during operation.

Background knowledge for understanding more easily the present specification may be found in the article of L. Strazzera, V. Gori and G. Veneri entitled “DANNTe: a case study of a turbo-machinery sensor virtualization under domain shift” and published in 2021 in connection with the Conference on Neural Information Processing Systems and in the article of Y. Ganin et al. entitled “Domain-Adversarial Training of Neural Networks” and published in 2016 by the Journal of Machine Learning Research.

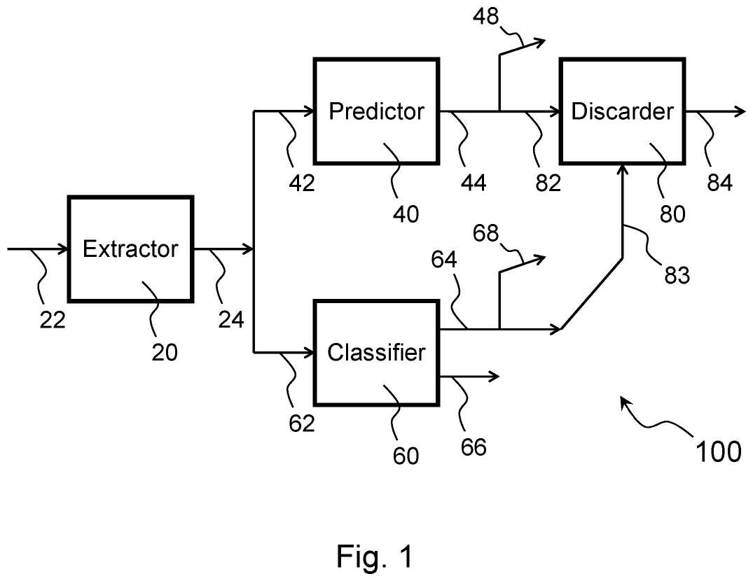

FIG. 1 shows a schematic block diagram of an embodiment of an innovative virtual sensor 100. Virtual sensor 100 includes a features extractor 20, a predictor 40, a domain classifier 60 and a discarder 80. During operation of virtual sensor 100, feature extractor 20 receives input variable values, extracts feature values from the input variable values and provides feature values to predictor 40 and domain classifier 60. During operation of virtual sensor 100, predictor 40 makes predictions using the received feature values and outputs predicted output variable values, while domain classifier 60 receives the feature values, and, based on the received feature values, estimates the domain of the received input variable values and calculates reliability flags corresponding to the predicted output variable values output by predictor 40.

It is to be noted that, according to the embodiment of FIG. 1, the input variable values may come either from one or more physical sensors of a prototype machine installed and operating in a test environment, i.e. a “first domain” (so-called “source domain”), or from one or more physical sensors of an industrial machine installed and operating in a production environment, i.e. a “second domain” (so-called “target domain”), but not both machines at the same time; indeed, especially (but not only) during a training period, a set of input variable values may be provided to the virtual sensor grouped in a so-called “batch” and a batch advantageously contains data from the “source domain” and the “target domain” even if they are not really processed at the same time but simply during the same time period. Therefore, domain classifier 60 is able to understand (more precisely, estimate) whether input variable values received by the virtual sensor(s) at a certain time come from the “first domain” or the “second domain” and to determine the “domain loss”; if data batches are used during a training period, the output from the domain classifier may be an average value deriving from all data of the batch, for example an average domain loss. Usually, input variable values come from the “first domain” and the “second domain” during training of the virtual sensor and only from the “second domain” afterwards; if data batches are used, a single batch may contain data from the “first domain” only, data from the “second domain” only, data from the “first domain” and the “second domain”. As already explained, there may be a delay between the time when data are detected by the physical sensors and the time when data are processed by the virtual sensor. In general, the number of domains may be more than two; for example, there may be more than one protype machine used for the training.

As explained afterwards, domain classifier 60 is also able to calculate reliability flags corresponding to the predicted output variable values output by predictor 40. In other words, according to the embodiment of FIG. 1, domain classifier 60 is also able to understand (more precisely, estimate) whether output variable values output by predictor 40 at a certain time are reliable or not; in general, this changes from time to time so the reliability flag changes from time to time.

According to the embodiment of FIG. 1, during operation of virtual sensor 100, discarder 80 receives predicted output variable values output from predictor 40 and corresponding reliability flags from domain classifier 60, discards those values that are considered unreliable based on the calculations/estimations of domain classifier 60 and outputs only reliable values.

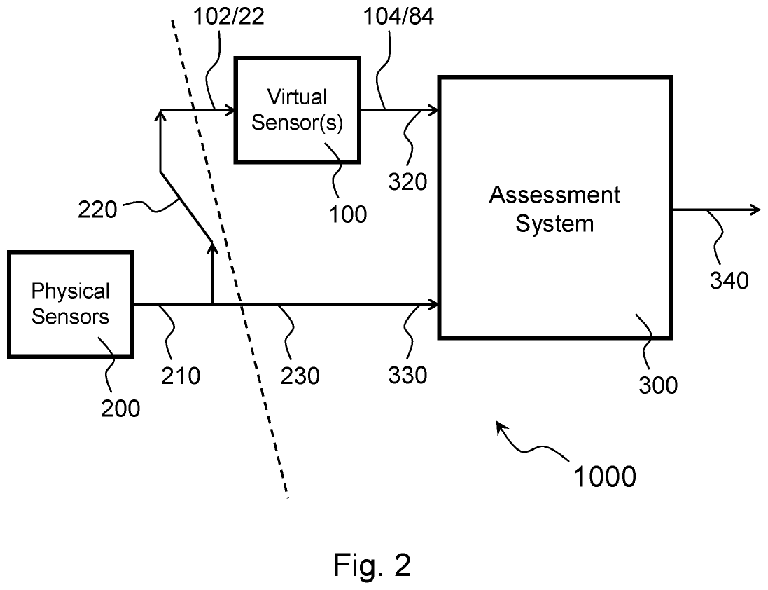

As shown in FIG. 2, innovative virtual sensor 100 may be a component of an innovative assessment system 1000, i.e. a computer-implemented system, able to make assessments on an industrial machine (or equivalently, an industrial system or an industrial plant) typically in production condition. In the embodiment of FIG. 2, some input(s) of a prior-art assessment system 300 are coupled with some physical sensor(s) 200 of the industrial machine and some other input(s) of system 300 are coupled with the output(s) of virtual sensor 100. The input(s) of virtual sensor 100 are coupled with some physical sensor(s) 200 of the industrial machine. It is to be noted that physical sensor(s) 200 of the industrial machine is/are external to the innovative assessment system 1000 (see inclined dashed line).

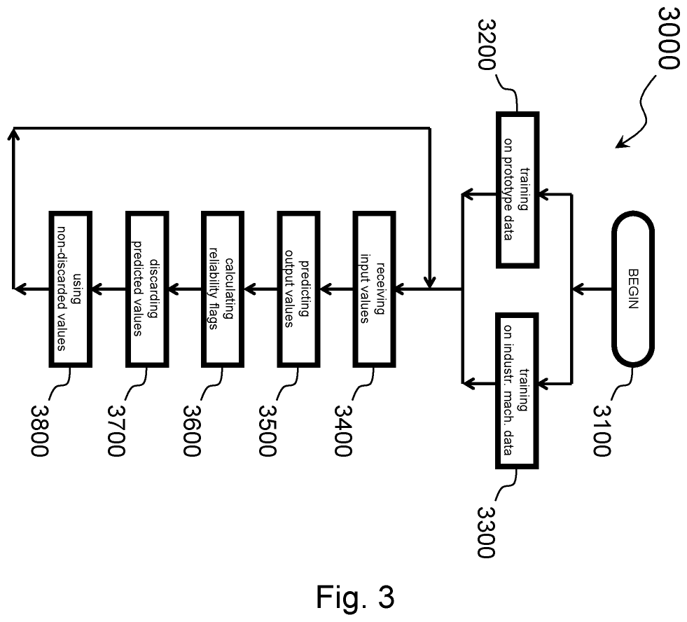

An embodiment of an innovative method of generating an output signal from a virtual sensor of an industrial machine is shown in FIG. 3; this method (as well as other method embodiments) is a so-called “computer-implemented method”. It is to be noted that the arrows in this flowchart do not represent flows of data, but only flows of control; in particular, data generated by the activity of block 3800 are not to be intended as provided in input to the activity of block 3400. Flowchart 3000 of FIG. 3 has a BEGIN block 3100 and a number of following blocks. Blocks 3200 and 3300 (that will be described in detail later) correspond to method steps carried out before machine operation time, i.e. during training time of the innovative virtual sensor, while blocks 3400, 3500, 3600, 3700 and 3800 (that will be described in detail later) correspond to method steps carried out during machine operation time, i.e. after training time of the innovative virtual sensor. In flowchart 3000 of FIG. 3, there is no END block as if the innovative virtual sensor never stops working; however, it is to be understood that the innovative virtual sensor may be stopped at any time by an “external command” that may be issued by an operator and/or by a piece of software. In flowchart 3000 of FIG. 3, blocks 3400, 3500, 3600, 3700 and 3800 form a loop and repeat cyclically; depending on the specific embodiment, repetition may occur for each new set of input variable values, e.g. for any new set of values provided to the inputs of the innovative virtual sensor at a certain time—for example, if the virtual sensor has only one input variable, repetition may occur at any new value of the input variable provided to the sensor input.

According to the method of FIG. 3 (as well as other method embodiments), the input signal of the innovative virtual sensor corresponds to a sequence of values of an input variable of a software model and the output signal of the innovative virtual sensor corresponds to a sequence of values of an output variable of a software model. In general, there is a number of input variables and consequently a corresponding number of input signals. In general, there may be more than one output variables and consequently more than one output signals; this means that the innovative virtual sensor may “virtually” measure more than one variable inside an industrial system at the same time. The input variables relate to physical quantities of the industrial system and the output variable(s) relates to measurement or evaluation of a parameter (that may also be a physical quantity) of the industrial system.

The method of FIG. 3 (as well as other method embodiments) comprises at least the following steps to be performed during machine operation time:
a) receiving (block 3400 in FIG. 3) at least one input sequence of values of an input variable of the software model,
b) predicting (block 3500 in FIG. 3) an output sequence of values of the output variable through the software model based on the at least one input sequence,
c) for one or more or all of the values of the predicted output sequence calculating (block 3600 in FIG. 3) a corresponding a flag and/or value, regarding a reliability and/or a statistical evaluation of the prediction values,
d) discarding (block 3700 in FIG. 3) none or one or more of the values of the predicted output sequence based on the corresponding flags and/or values—the number of discarded values depends on the values of the flags and/or of the values, and
e) using (block 3800 in FIG. 3) only the non-discarded values of the predicted output sequence as the output signal.

Step b) follows step a) after some time. Depending on the embodiment, this may be a very short time, e.g. microseconds if this delay is due only to the processing time of a microprocessor, or a very long time, e.g. days or weeks or months if the delay is due to the storage of data previously collected from an industrial machine. In other words, the delay may depend on wherefrom the values are received.

It is to be noted that at step b) there is typically an output value in the output sequence for each input value in the input sequence.

Furthermore, it is to be noted that the calculation at step c) does not necessarily occur for each of the values of the predicted output sequence.

The software model of the method is advantageously an artificial intelligence software model, in particular a machine learning artificial intelligence software model.

Step c) offers basically two possibilities; these possibilities may be alternative or even used at the same time. According to a first possibility, which is easier to be implemented, a prediction reliability flag is calculated for e.g. each of the prediction values of step b); in particular, according to this first possibility, the flag is “true” if the corresponding prediction value is to be considered reliable. According to a second possibility, a statistical evaluation value is calculated for e.g. each of the prediction values of step b); in particular, according to this second possibility, the value is a confidence level and corresponds to the probability that the prediction value is correct.

Regarding step e), more details will be provided in the following. It is to be noted that also the output of step b), i.e. before the discarding of step d), may have a useful purpose specially during training time.

The method of FIG. 3 (as well as other method embodiments) advantageously comprises the following preliminary step to be performed before machine operation time:
training (blocks 3200 and 3300 in FIG. 3) the software model at least on a source domain different from a target domain that corresponds to machine operation time.

More advantageously, the software model is trained both on the source domain and on the target domain. In FIG. 3, block 3200 and block 3300 are in parallel as, in general, training with source domain data and training with target domain data totally or partially overlap as such two training activities may be considered contemporaneous. As already explained, for example, there may be a sequence of training data batches containing both source domain data and target domain data, or, for example, there may be a sequence of alternating training data batches containing only source domain data and training data batches containing only target domain.

The above-mentioned preliminary step may comprise:
training (block 3200 in FIG. 3) the software model at least on data collected from a prototype machine different from the industrial machine input variable(s) and output variable(s) values from the prototype should be used in this case.

It is to be noted that typically a “prototype machine” includes a number of physical sensors much higher than a “fleet machine”, for example ten times higher.

The above-mentioned preliminary step may comprise:
training (block 3300 in FIG. 3) the software model also on data collected from the industrial machine-only input variable(s) values from the industrial machine should be used in this case.

It is to be noted that it is possible that training of the virtual sensor be based on more prototype machine data than industrial machine data; in other words, advantageously, it is possible that training of the virtual sensor does not require a long activity with the industrial machine during production. In fact, a loss-weighting mechanism may be put in place in order to compensate for the different amounts; for example, the domain losses when training processing industrial machine data may have a higher weight than the training domain losses when processing prototype machine data if the amount of training prototype machine data is bigger than the amount of training prototype machine data.

According to method of FIG. 3 (as well as other method embodiments) the software model is typically implemented through a neural network; advantageously, the training is a domain-adversarial training of the neural network. In particular, the software model is implemented through a first neural network configured to embody a features extractor, a second neural network configured to embody a domain classifier, and a third neural network configured to embody a predictor, and the training is a domain-adversarial training of the whole neural network being the assembly of the first and second and third neural networks. More in particular, the first neural network (i.e. the “features extractor”) is trained on both the source domain and the target domain, the second neural network (i.e. the “domain classifier”) is trained on both the source domain and on the target domain, and the third neural network (i.e. the “predictor”) is trained on only the source domain.

The calculations at step c) (of the flags and/or the values) may be performed by a domain classifier based on the at least one input sequence of values and provides e.g. domain loss flags; preferably, such calculations are preformed through a same single software model used for the prediction.

Validation of the software model may be performed even without any measurement of the output variable (corresponding to the output of the virtual sensor) on the industrial machine by considering another variable strictly correlated to the output variable.

The above-described method may be implemented through a machine learning artificial intelligence virtual sensor for an industrial machine (or equivalently, an industrial system or an industrial plant), as for example sensor 100 shown in FIG. 1.

An innovative virtual sensor comprises in general:
a features extractor (labelled 20 in the embodiment of FIG. 1) having one or more variable inputs (labelled 22 in the embodiment of FIG. 1) and one or more feature outputs (labelled 24 in the embodiment of FIG. 1), the one or more variable inputs being configured to be coupled to corresponding one or more physical sensors of the industrial machine, the feature extractor being configured to output feature values at the one or more features outputs,
a predictor (labelled 40 in the embodiment of FIG. 1) having one or more feature inputs (labelled 42 in the embodiment of FIG. 1) and at least one variable output (labelled 44 in the embodiment of FIG. 1), the feature inputs of the predictor being coupled to the feature outputs of the features extractor, the predictor being configured to output a sequence of variables predicted values at the least one variable output,
a domain classifier (labelled 60 in the embodiment of FIG. 1) having one or more feature inputs (labelled 62 in the embodiment of FIG. 1), and a domain loss output (labelled 64 in the embodiment of FIG. 1), the feature inputs of the domain classifier being coupled to the feature outputs of the features extractor, the domain classifier being configured to output a sequence of domain loss flags at the domain loss output,
a discarder (labelled 80 in the embodiment of FIG. 1) having a loss input (labelled 83 in the embodiment of FIG. 1), the loss input being coupled to the domain loss output of the domain classifier, the discarder being configured to signal internally and/or externally a discarding action (that may be also only a possibility of discarding action) on a variable predicted value if a corresponding domain loss value is above a predetermined threshold—such signaling may occur through a signal (not shown in FIG. 1) internal to the discarder that may be also provided e.g. at a specific output of the discarder (not shown in FIG. 1);
depending on the specific embodiment, the output of the virtual sensor (labelled 100 in the embodiment of FIG. 1) may correspond to the output of the discarder (labelled 80 in the embodiment of FIG. 1) or to a combination of the output of the predictor (labelled 40 in the embodiment of FIG. 1) and the output of the discarder (labelled 80 in the embodiment of FIG. 1), the virtual sensor (labelled 100 in the embodiment of FIG. 1) is configured so:
at training time, the features extractor, the classifier and the predictor are active and the discarder is inactive,
at machine operation time, the features extractor, the classifier, the predictor and the discarder are active.

Basically, the innovative virtual sensor assumes that if the domain classifier judges that there is a domain loss, i.e. it is not able to estimate correctly the domain, also the output value predicted by the predictor is to be considered unreliable. If the domain classifier is also able for example to provide the domain with a certain confidence level, a corresponding confidence level (not necessarily the same) might be applicable to the output value predicted by the predictor.

It is to be noted that in the embodiment of FIG. 1 (as well as other sensor embodiments), predictor 40 and classifier 60 has specific outputs to be used at training time. In particular, output 48 corresponds to output 44, output 68 corresponds to output 64 and output 66 is additional and will be explained in the following.

Sensor 100 of FIG. 1 (as well as other sensor embodiments) includes a domain classifier 60 that has also a domain label output 66 and is configured to output a sequence of domain labels (i.e. the domain estimated from the input variable values at successive times) at output 66 to be used primarily at training time.

In the embodiment of FIG. 1 (as well as in other sensor embodiments), features extractor 20 may comprise or be a first neural network, domain classifier 60 may comprise or be a second neural network, and predictor 40 may comprise or be a third neural network.

In the embodiment of FIG. 1 (as well as in other sensor embodiments), discarder 80 is further advantageously configured to discard variable predicted values at the at least one variable output 44 of predictor 40 based on corresponding domain loss values.

In the embodiment of FIG. 1 (as well as in other sensor embodiments), discarder 80 is further configured to receive (at input 82) variable predicted values from the at least one variable output 44 of predictor 40 and to output (at output 84) non-discarded variable predicted values.

According to some sensor embodiments, the discarder is configured to store non-discarded variable predicted values.

According to some sensor embodiments, the discarder is configured to store information relating to discarding actions. For example, all the predicted values may be output and/or stored by the discarder together with the corresponding value relating to its reliability flag and/or to e.g. its confidence level; in this way, the decision regarding if and how to use the values predicted by the innovative virtual sensor is left to other devices or systems.

As already said, an innovative virtual sensor may be a component of an innovative computer-implemented system for making assessments on an industrial machine (or equivalently, an industrial system or an industrial plant) as shown for example in FIG. 2. In general, such an innovative assessment system may include a number of virtual sensors, some or all of them being innovative virtual sensors. In general, such an innovative assessment system may be configured to be coupled to a number of physical sensors, as shown for example in FIG. 2.

An innovative computer-implemented assessment system may be configured to execute a computational analysis computer programs and process data at least from one or more innovative virtual sensors (labelled 100 in the embodiment of FIG. 2) of the industrial machine to be assessed and possibly from one or more non-innovative virtual sensors (not shown in the embodiment of FIG. 2) of the industrial machine to be assessed and/or from one or more physical sensors (labelled 200 in the embodiment of FIG. 2) of the industrial machine to be assessed.

FIG. 2 shows physical sensors 200 of an industrial machine having corresponding outputs 210. A first set 220 of outputs 210 are coupled with inputs 102 of an innovative virtual sensor 100 (corresponding to the inputs 22 of features extractor 20 in FIG. 1) and a second set 230 of outputs 210 are coupled with a first set of inputs 330 of a “traditional” assessment system 300. Outputs 104 of innovative virtual sensor 100 (that may correspond to the outputs 84 of discarder 80 in FIG. 1) are coupled with a second set of inputs 320 of “traditional” assessment system 300. The “traditional” assessment system 300 has outputs 340 for providing assessment results based on data at its inputs 320 and 330.

It is to be noted that an assessment system, including an innovative assessment system, may be designed to make assessments on more than one industrial machine (or equivalently, industrial system or industrial plant).

1. A computer-implemented method of generating an output signal from a virtual sensor of an industrial machine, wherein the output signal corresponds to a sequence of values of an output variable of a software model, wherein the output variable relates to measurement or evaluation of a parameter of the industrial machine, wherein the method comprises the following steps to be performed during machine operation time:
a) receiving at least one input sequence of values of at least one input variable of the software model, wherein the at least one input variable relates to at least one physical quantity of the industrial machine,
b) predicting an output sequence of values of the output variable through the software model based on the at least one input sequence,
c) for one or more or all of the values of the predicted output sequence calculating a corresponding a flag and/or value, regarding a reliability and/or a statistical evaluation of the prediction values,
d) discarding values of the predicted output sequence based on the corresponding flags and/or values, and
e) using only the non-discarded values of the predicted output sequence as the output signal.

2. The method of claim 1, wherein the method comprises the following preliminary step to be performed before machine operation time:
training the software model at least on a source domain different from a target domain corresponding to machine operation time.

3. The method of claim 2, wherein the software model is implemented through a neural network, and wherein the training is a domain-adversarial training of the neural network.

4. The method of claim 2, wherein the preliminary step comprises:
training the software model at least on data collected from a prototype machine different from the industrial machine.

5. The method of claim 4, wherein the preliminary step comprises:
training the software model also on data collected from the industrial machine.

6. The method of claim 2, wherein at step c) the flag and/or value is calculated through a domain classifier configured to output domain loss flags and/or values based on the at least one input sequence preferably through the software model.

7. A machine learning artificial intelligence virtual sensor for an industrial machine, wherein an output of the virtual sensor relates to measurement or evaluation of a parameter of the industrial machine, wherein the virtual sensor comprises:
a features extractor having one or more variable inputs and one or more feature outputs, the one or more variable inputs being configured to be coupled to corresponding one or more physical sensors of the industrial machine, the feature extractor being configured to output feature values at the one or more features outputs,
a domain classifier having one or more feature inputs and a domain loss output, the feature inputs being coupled to the feature outputs the domain classifier being configured to output a sequence of domain loss flags at the domain loss output,
a predictor having one or more feature inputs and at least one variable output, the feature inputs being coupled to the feature outputs, the predictor being configured to output a sequence of variable predicted values of at the least one variable output,
a discarder having a loss input, the loss input being coupled to the domain loss output, the discarder being configured to signal a discarding action on a variable predicted value if a corresponding domain loss value is above a predetermined threshold, wherein the output of the virtual sensor corresponds to the output of the discarder or to a combination of the output of the predictor and the output of the discarder, wherein the virtual sensor is configured so that:
at training time, the features extractor, the classifier and the predictor are active and the discarder is inactive,
at machine operation time, the features extractor, the classifier, the predictor and the discarder are active.

8. The virtual sensor of claim 7, wherein the features extractor comprises a first neural network, wherein domain classifier comprises a second neural network, and wherein predictor comprises a third neural network.

9. The virtual sensor of claim 7, wherein the discarder is further configured to discard variable predicted values at the at least one variable output based on corresponding domain loss values.

10. The virtual sensor of claim 9, wherein the discarder is further configured to receive variable predicted values from the at least one variable output and to output non-discarded variable predicted values.

11. The virtual sensor of claim 9, wherein the discarder is further configured to store non-discarded variable predicted values.

12. The virtual sensor of claim 11, wherein the discarder is further configured to store information relating to discarding actions.

13. A computer-implemented system for making an assessment on an industrial machine, the system comprising:
at least one virtual sensor of the industrial machine according to claim 7.

14. The computer-implemented system of claim 13, the system being configured to execute a computational analysis computer programs and process data at least from the virtual sensor of the industrial machine and possibly from one or more physical sensors of the industrial machine.
